(19) United States
(12) Patent Application Publication
(10) Pub. No.: US 2009/0062992 A1
(43) Pub. Date: Mar. 5, 2009

(54) MOTOR VEHICLE WITH A NAVIGATION SYSTEM AND AN AFL-HEADLIGHT SYSTEM

(75) Inventors: Malte JACOBS, Ginsheim-Gustavsburg (DE); Dirk BALZER, Nierestein (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/195,293

(22) Filed: Aug. 20, 2008

(30) Foreign Application Priority Data
Sep. 3, 2007 (DE) 102007041703.0

(51) Int. Cl. G08G 1/0967; G02B 26/08

(52) U.S. Cl. 701/49; 701/117

(57) ABSTRACT

A motor vehicle is provided that has a navigation system and an AFL-headlight system. The alignment of at least one headlight of the motor vehicle can be influenced with the information of the navigation system. In order to improve the illumination of road sections lying ahead, a number of traffic lanes are taken into consideration in the alignment of the headlight.

### CROSS-REFERENCE TO RELATED APPLICATION

This application claims priority to German Patent Application No. 102007041703.0, filed Sep. 3, 2007, which is incorporated herein by reference in its entirety.

### TECHNICAL FIELD

The technical field generally relates to a motor vehicle with a navigation system and an AFL-headlight system, and the alignment of at least one headlight of the motor vehicle that can be influenced with the information of the navigation system.

### BACKGROUND

Motor vehicles are frequently equipped with a navigation system that works, among other things, in order to determine a route from a current position that can be established with the aid of the GPS-system or prospectively a Galileo-system to a destination that can be specified by the user of the motor vehicle, as well as for outputting corresponding directional information. In this case, traffic messages and user specifications, such as the exclusion of toll roads or the like, can be taken into consideration.

In addition, modern motor vehicles also feature an Adaptive Forward Lighting (AFL)-headlight system, in which either the two already existing or additional front headlights can be pivoted about a vertical axis, for example, in accordance with the steering wheel deflection angle in order to also optimally illuminate the road lying ahead while maneuvering through a curve. In addition, the headlight or headlights or their light cones can be respectively pivoted about a horizontal axis in order to compensate possibly varying angles of inclination of the vehicle body.

Motor vehicles of this type are known from EP 1 415 856 A1, DE 197 27 593 A1, DE 103 47 552 A1 and DE 101 39 152 A1, and the AFL-headlight system is respectively controlled with consideration of signals of the navigation system. If information received from the navigation system indicates that the vehicle is about to be driven through a curve, the headlights can already be correspondingly aligned in order to illuminate the curved road section before actually maneuvering the vehicle through the curve. Consequently, obstacles can be detected in a timely fashion. This type of control, which takes into consideration the signals of the navigation system, can be realized with a central control device of the motor vehicle or with a control device of the AFL-headlight system.

Although known AFL-headlight systems make it possible to already illuminate curves lying ahead with the aid of the information provided by the navigation system, this does not suffice, particularly on multi-lane roads, for sufficiently illuminating a road section to be actually maneuvered.

In view of the foregoing, at least one objective is to provide a motor vehicle of the initially cited type, in which it is ensured, particularly on expressways, that the road sections to be actually maneuvered are sufficiently illuminated. In addition, other desirable objectives, features and characteristics will become apparent from the subsequent summary and detailed description, and the appended claims, taken in conjunction with the accompanying drawings and this background.

### SUMMARY

According to the invention, this objective is attained in that a number of traffic lanes are taken into consideration in the alignment of the headlight. More specifically, in accordance with at least one embodiment. A motor vehicle with a navigation system and an AFL-headlight system are provided and the alignment of at least one headlight of the motor vehicle can be influenced with the information of the navigation system The information on a number of traffic lanes is available in the navigation system and taken into consideration in the alignment of the headlight.

A thusly designed motor vehicle or AFL-headlight system respectively makes it possible to also illuminate laterally adjacent traffic lanes and/or regions of adjacent traffic lanes that laterally lie ahead, particularly on multi-lane roads such as freeways, expressways or the like, and this road section is already illuminated, in particular, during an intended lane change in order to detect an obstacle in a timely fashion. For example, the navigation system is able to determine, particularly in connection with a camera system of an image processing system for monitoring the vehicle exterior, that the motor vehicle is traveling in the left lane and a change into the right lane is imminent (e.g., because the vehicle is about to exit the expressway in accordance with the calculated route to the destination). The AFL-headlight system is accordingly controlled in such a way that it already illuminates a left or right region of the road that laterally lies ahead in order to monitor this region or to point out this direction to the driver.

The corresponding information with respect to the actually existing number of traffic lanes is available in the navigation system because the existing roads, as well as the road types, such as multi-lane expressways or single-lane rural roads, are stored as information in the corresponding data memory. In countries with left-hand traffic, the corresponding information with respect to the traffic lanes and driving directions naturally can be taken into consideration, and an automatic change-over can be realized in accordance with the state of the art based on available navigation data that is linked with corresponding traffic control data.

The corresponding data of the navigation system may either be taken into consideration in a central control device or in a control device of the AFL-headlight system, respectively, and this can usually be realized with only insignificant hardware and/or software modifications of an already existing control device.

Naturally, the illumination of lateral regions or regions that laterally lie ahead by means of the AFL-headlight system is realized by conventionally pivoting the existing front headlights of the motor vehicle or their light cones, respectively, or by aligning the light cones of additional headlights arranged in the front region or lateral region of the motor vehicle. It would also be possible, in principle, to control the two headlights on both sides of the motor vehicle independently of one another in order to differently illuminate the left and right regions that lie ahead in the driving direction, wherein no restrictions of a basic illumination are intended.

In addition to multiple traffic lanes, the presence of an intersection can also be taken into consideration under the aforementioned aspects.

It is preferred that a traffic lane to be presumably traveled can be taken into consideration in the control of the AFL-headlight system. If the vehicle is driven in the left traffic lane of a multi-lane road as determined by the navigation system in connection with the camera system based on the actual position of the motor vehicle and a presumable lane change into the right traffic lane is imminent, this may be realized by already illuminating this right traffic lane. The presumption that the vehicle will soon be traveling in a different traffic lane can be deduced, for example, based on the fact that the vehicle is about to exit the expressway in accordance with the pre-calculated route to be traveled.

The AFL-headlight system can also be controlled in this fashion if the vehicle is about to travel in a turn lane or merging lane. In the region of intersections, it is common practice to provide a separate traffic lane for vehicles turning left. If the driver should turn left at such an intersection in accordance with information of the navigation system, this road section can already be illuminated by the AFL-headlight system. Naturally, this also applies to a right-turn lane. It is also possible to already illuminate a merging lane or turn lane of a multi-lane road before the vehicle actually travels in this lane in order to point out the turn to be made to the driver of the motor vehicle beforehand.

In addition, internal vehicle data such as, among other things, a steering wheel deflection angle, a set driving direction indicator, the position of a brake and/or accelerator pedal and an angle of inclination of the car body, preferably is also taken into consideration in the alignment of the AFL-headlight system so as to prevent the drivers of oncoming vehicles from being blinded. This type of control, in which internal vehicle data is also taken into consideration, can basically also be realized while the navigation system is switched off.

In order to improve the illumination of road sections to be maneuvered, it is preferably also possible to take into consideration the information of an image processing system that is provided in the motor vehicle and comprises a camera system. Such an image processing system makes it possible, for example, to detect the lateral lane markings in order to determine when the vehicle crosses these markings (e.g., due to fatigue of the driver, and to output corresponding warning signals, etc.). Image processing systems of this type also make it possible to detect traffic signs in order to determine that the vehicle approaches an intersection and to alert the driver, particularly if the vehicle travels with an excessive speed. Image processing systems can also detect the presence of a turn lane or merging lane and the presence of several traffic lanes in the driving direction or an intersection. The AFL-system is aligned accordingly, for example, in order to also illuminate the turn lane or an adjacent traffic lane. The image processing system can also detect the presence of other participants in traffic such that blinding of the driver of an oncoming vehicle is prevented, particularly while turning, due to the alignment of the AFL-headlight system in the turning direction. If such a presence is detected, the headlight can be aligned, for example, downward in order to only illuminate the road section itself. The image processing system also makes it possible to detect temporary obstacles that are not stored in the navigation system and can also be illuminated, for example, a broken-down vehicle on the side of the road. Furthermore, the coupling of the information of the image processing system and the data of the navigation system makes it possible to define exact position data for controlling a headlight. However, such exact position data can currently not be obtained with conventional navigation systems intended for non-military use alone. The image processing system makes it possible to also detect leading and oncoming vehicles such that blinding of other participants in traffic can be precluded.

Embodiments are also provided in which regions that lie behind the motor vehicle referred to the driving direction are also illuminated by the AFL-headlight system, particularly during a traffic lane change, such that motor vehicles in the so-called blind spot can also be detected.

### BRIEF DESCRIPTION OF THE DRAWINGS

The present invention will hereinafter be described in conjunction with the following drawing figures, wherein like numerals denote like elements, and

FIG. 1 shows a block diagram of several components of a motor vehicle in accordance with an embodiment; and

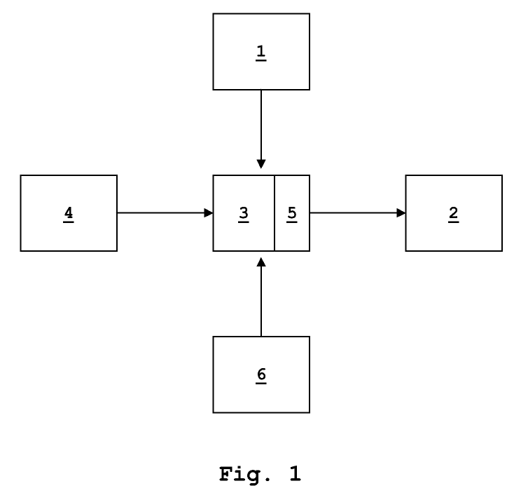

FIG. 2 schematically shows the illumination of regions situated in front of the motor vehicle.

### DETAILED DESCRIPTION

The following detailed description is merely exemplary in nature and is not intended to limit application and uses. Furthermore, there is no intention to be bound by any theory presented in the preceding background and summary or the following detailed description.

The motor vehicle 8 is equipped with a navigation system 1 for outputting directional information for driving from the current position to a destination specified by the user, as well as an AFL-headlight system 2, in which one or more headlights or their light cones, respectively, can essentially be pivoted about a vertical axis and aligned.

In a central control device 3 or a control device of the AFL-headlight system 2, the data of the navigation system 1 and, if applicable, other vehicle data 4 such as the angle of inclination, the steering wheel deflection angle and the like, are taken into consideration in order to control the AFL-headlight system 2 accordingly. The central control device 3 also features an evaluation unit 5 that makes it possible to determine if the vehicle is currently traveling on a multi-lane road or if the vehicle is about to turn or merge in a separate traffic lane. Corresponding information of the navigation system is already available in the motor vehicle and can be respectively taken into consideration by the central control device 3 and the evaluation unit 5.

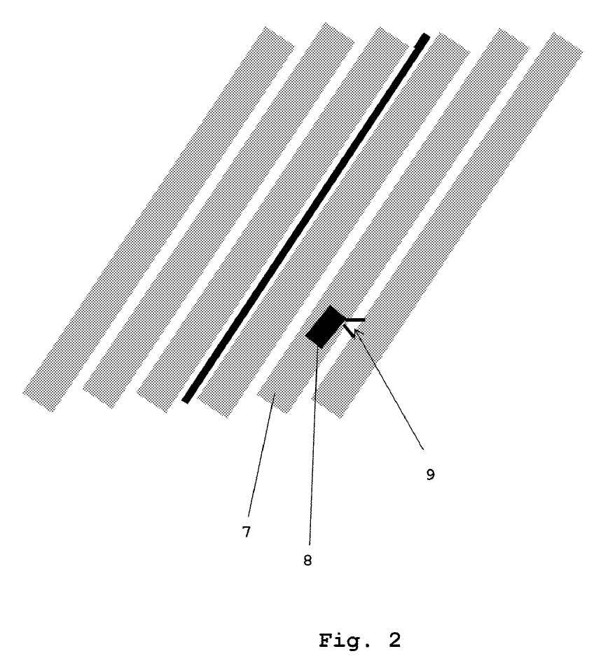

For example, if a lane change is imminent on a multi-lane road 7 as illustrated in FIG. 2, a region lying ahead on the right or the traffic lane lying ahead on the right can already be illuminated by means of the AFL-headlight system 2 prior to the actual lane change as indicated by the schematic headlight cone 9 in order to ensure a safe lane change. The fact that such a lane change is imminent can be deduced by the navigation system 1 because the vehicle is about to exit the multi-lane road in accordance with the route pre-calculated in the navigation system 1. Corresponding adjustments such as the distances at which or time periods for which the respective road sections should already be illuminated beforehand can either be specified by the user or configured at the factory with consideration of maximum traffic safety.

The motor vehicle 8 also features an image processing system 6, for example, a camera with corresponding image processing software. The image processing system 6 makes it possible to detect the presence of other participants in traffic, such as a leading motor vehicle, or the presence of a traffic obstacle, such as a broken-down motor vehicle. For example, if a breakdown assistance vehicle is registered in the emergency lane, the AFL-headlight system 2 can be controlled accordingly in order to illuminate this obstacle and to thusly lower the risk of a collision. If the information of the image processing system 6 is taken into consideration, blinding of oncoming participants in traffic can also be prevented, particularly during a turning maneuver.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A system of a motor vehicle, comprising:
a navigation system configured to provide information on a number of available traffic lanes; and
an AFL-headlight system having at least one headlight that is configured to align based at least in part on the information on the number of available traffic lanes provided by the navigation system.

2. The system for the motor vehicle according to claim 1, wherein the navigation system is further configured to provide information on a presence of an intersection and the at least one headlight is further configured to align based at least in part on the presence of an intersection.

3. The system for the motor vehicle according to claim 1, wherein the at least one headlight is aligned based at least in part on identification of a future traffic lane to be traveled by the motor vehicle.

4. The system for the motor vehicle according to claim 1, wherein the at least one headlight is further configured to align based at least in part on a presence of a turn lane.

5. The system for the motor vehicle according to claim 1, wherein the at least one headlight is further configured to align based at least in part on a present of a merging lane.

6. The system for the motor vehicle according to claim 1, wherein at least one headlight is further configured to align based at least in part on internal data of the motor vehicle.

7. The system for the motor vehicle according to claim 1, further comprising an image processing system configured to generate an image, wherein the at least one headlight is further configured to align based at least in part on the image generated by the image processing system.
